(19) United States
(12) Patent Application Publication
(10) Pub. No.: US 2024/0111999 A1
(43) Pub. Date: Apr. 4, 2024

(54) SEGMENTING AND CLASSIFYING UNSTRUCTURED TEXT USING MULTI-TASK NEURAL NETWORKS

(71) Applicant: Google LLC, Mountain View, CA (US)

(72) Inventors: Itay Laish, Timrat (IL); Amir Reuven Feder, New York, NY (US); Fan Zhang, Cupertino, CA (US); Ayelet Benjamini, Kfar Saba (IL)

(21) Appl. No.: 18/375,960

(22) Filed: Oct. 2, 2023

Related U.S. Application Data
(60) Provisional application No. 63/412,353, filed on Sep. 30, 2022.

(51) Int. Cl. G06N 3/0455; G06N 3/048

(52) U.S. Cl. CPC G06N 3/0455; G06N 3/048

(57) ABSTRACT

A multi-task neural network system is described. The system includes a shared neural network configured to receive as input a text span from a clinical note, and for each of one or more text segments in the text span, processing the text segment to generate a set of text segment embeddings. The system further includes a segmentation neural network configured to, for each of the one or more text segments, process the respective set of text segment embeddings to determine whether the text segment is a section title or not. The system further includes a section type classification neural network configured to, for each of the one or more text segments, process the respective set of text segment embeddings to classify the text segment into a section type of a plurality of section types.

### CROSS REFERENCE TO RELATED APPLICATIONS

This application is a non-provisional of and claims priority to U.S. Provisional Patent Application No. 63/412,353, filed on Sep. 30, 2022, the entire contents of which are hereby incorporated by reference.

### BACKGROUND

This specification relates to neural networks for segmenting and classifying unstructured text.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a multi-task neural network system implemented as computer programs on one or more computers in one or more locations for segmenting and classifying unstructured text in a clinical note.

In general, one innovative aspect of the subject matter described in this specification can be embodied in a multi-task neural network system that includes one or more computers and one or more non-transitory computer storage media storing instructions that, when executed by the one or more computers, cause the one or more computers to implement a shared neural network, a segmentation neural network, and a section type classification neural network. The shared neural network is configured to: receive as input a text span from a clinical note, in which the text span includes one or more text segments, and for each of the one or more text segments in the text span, process the text segment to generate a set of text segment embeddings. The segmentation neural network is configured to, for each of the one or more text segments, process the respective set of text segment embeddings to determine whether the text segment is a section title or not. The section type classification neural network is configured to, for each of the one or more text segments, process the respective set of text segment embeddings to classify the text segment into a section type of a plurality of section types, wherein the section type characterizes a type of a clinical procedure that resulted in the clinical note being generated.

The foregoing and other embodiments can each optionally include one or more of the following features, alone or in combination. The shared neural network may include an attention neural network. The shared neural network includes one or more fully-connected neural network layers with dropout. The attention neural network may be a Transformer neural network. The attention neural network may be a bidirectional Transformer encoder neural network. The segmentation neural network may include an encoder neural network. The section type neural network may include one or more fully-connected neural network layers and a softmax neural network layer. The multi-task neural network system may further include a note type prediction neural network configured to, for each of the one or more text segments, process the respective set of text segment embeddings to determine a note type of the text segment, wherein the note type characterizes a type of patient interaction that resulted in the clinical note being generated. The note type neural network includes one or more fully-connected neural network layers and a softmax neural network layer. The segmentation neural network, the section type classification neural network and the note type prediction neural network may be jointly trained to optimize a combined loss function. The combined loss function may be a combination of (i) a segmentation loss that ensures an accuracy of classifying a text segment as a section title or not, (ii) a section type loss that ensures an accuracy of classifying a text segment into a section type of the plurality of section types, and (iii) a note type loss that ensures an accuracy of determining a note type for a text segment, wherein the note type is one of a plurality of note types. The combined loss function may be a weighted sum of a segmentation loss, a section type loss, and a note type loss.

Another innovative aspects of the subject matter described in this specification can be embodied in a computer-implemented method for segmenting and classifying unstructured text in a clinical note using a multi-task neural network system that includes a shared neural network, a segmentation neural network, and a section type classification neural network. The method includes receiving, by a shared neural network, as input a text span from a clinical note, in which the text span includes one or more text segments, and for each of the one or more text segments in the text span, processing the text segment to generate a set of text segment embeddings; for each of the one or more text segments, processing, by a segmentation neural network, the respective set of text segment embeddings to determine whether the text segment is a section title or not; and for each of the one or more text segments, processing, by a section type classification neural network, the respective set of text segment embeddings to classify the text segment into a section type of a plurality of section types, wherein the section type characterizes a type of a clinical procedure that resulted in the clinical note being generated.

Other innovative aspects of the subject matter described in this specification can be embodied in one or more non-transitory storage media encoded with instructions that when implemented by one or more computers cause the one or more computers to implement the system and method described above.

The subject matter described in this specification can be implemented in particular embodiments so as to realize one or more of the following advantages.

Clinical notes often contain useful information not documented in structured data. The unstructured nature of clinical notes can lead to critical patient-related information being missed. Previous methods for organizing a clinical note into distinct sections often assume a given partition over the clinical note, and classify section types given this assumed partition. Thus, these methods often fail to correctly classify sections across different healthcare systems (e.g., different hospital departments, different care providers or different Electronic Health Records (EHR) systems). These limitations decrease the utility of previous methods in practice.

To address the drawbacks of conventional techniques, the techniques described in this specification use a multi-task neural network system that can segment unstructured text in a clinical note into a plurality of sections and determine a section title and a section type for each of the plurality of sections. As the multi-task neural network system has multiple neural networks that are trained jointly on segmentation/classification tasks, the system can understand the correlations between the type of the sections and the structure of the sections in the note, and therefore can identify note sections more accurately and can identify them across different hospital systems while conventional systems cannot. In addition, the techniques described herein can be used to label each section in a clinical note with the respective section title, and organize the labeled sections according to their section types, thus allowing patients and medical professionals to access and review the patient information in a given note and across different notes more easily.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example multi-task neural network system for segmenting and classifying unstructured text in a clinical note.

FIG. 2 shows example section types.

FIG. 3 is a flow diagram of an example process for segmenting and classifying unstructured text in a clinical note.

FIG. 4 is a flow diagram of an example process for jointly training the shared neural network, the segmentation neural network, the section type classification neural network, and optionally, the note type prediction neural network. Like reference numbers and designations in the various drawings indicate like elements.

### DETAILED DESCRIPTION

This specification describes a multi-task neural network system implemented as computer programs on one or more computers in one or more locations for segmenting and classifying unstructured text in a clinical note.

The unstructured text in the clinical note may include narrative descriptions or written records of a patient's medical history, symptoms, examinations, diagnoses, treatments, and/or other medical-related information. The unstructured text may be entered by healthcare providers, such as physicians, nurses, or other medical professionals, into the patient's medical record. Unlike structured data, which is organized and follows a predefined format or template, unstructured clinical notes are free-text in nature, allowing healthcare providers to document a patient's condition and treatment in a more timely, flexible, and detailed manner.

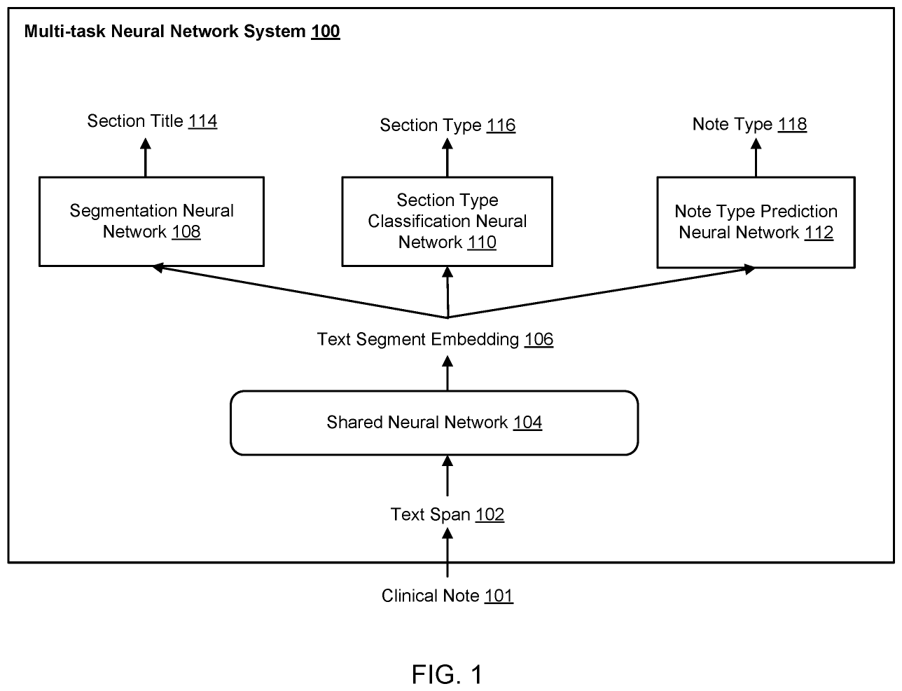

FIG. 1 shows an example multi-task neural network system 100 for segmenting and classifying unstructured text in a clinical note. The system 100 is an example of a system implemented as computer programs on one or more computers in one or more locations, in which the systems, components, and techniques described below can be implemented.

The multi-task neural network system 100 includes a shared neural network 104, a segmentation neural network 108, and a section type classification neural network 110.

The multi-task neural network system 100 is configured to receive a clinical note 101 as input and process the clinical note to generate multiple text spans. Each of the text spans identifies a section of a plurality of sections separated by separator tokens in the text of the clinical note.

In some implementations, the separator tokens include line breaks. The system 100 is configured to detect line breaks in the text of the clinical note and split the text into multiple text spans where there is a line break.

In some implementations, the separator tokens include title endings. The system 100 is configured to detect one or more sentences that end with a title ending such as “:” or “-”. The system 100 is then configured to split the text of the clinical note 101 into multiple text spans where there is a title ending. Each text span identifies a section in the clinical note.

The shared neural network 104 is configured to receive as input a text span (e.g., text span 102) from a clinical note 101. The text span 102 includes one or more text segments. A text segment may be a phrase, a sentence, or a paragraph, or any other appropriate collection of text tokens, where a text token can be, e.g., a character, a word, a word piece, or any other appropriate text token. Generally, the shared neural network 104 is configured to process each text segment to generate a text segment embedding 106.

In particular, the shared neural network 104 is a deep neural network. In some implementations, the shared neural network 104 includes a Transformer neural network and a fully connected neural network layer. For example, the Transformer neural network can be a bidirectional Transformer encoder neural network and the at least one fully connected neural network layer can include a dense layer. The Transformer neural network is configured to process each text segment to generate a respective vector representation of the text segment.

The fully connected neural network layer is configured to receive each vector representation generated by the Transformer neural network for each text segment and to process each vector representation to generate a respective text segment embedding for the text segment.

In some implementations, the shared neural network 104 includes a dropout neural network layer. The dropout neural network layer is configured to assign a zero value to one or more of the text segment embeddings to avoid overfitting. In some implementations, the dropout layer is configured to randomly assign a zero value to one or more of the text segment embeddings.

The segmentation neural network 108 is configured to, for each of the one or more text segments, process the respective text segment embedding 106 to determine whether the text segment is a section title 114 or not.

In particular, the segmentation neural network 108 is configured to determine whether the text segment includes a marker that corresponds to text that is usually used as the header of section. For example, PMH is a marker that is used as the header of the section Past Medical History. Each marker belongs to a predetermined set of markers. If the segmentation neural network 108 determines that the text segment includes a marker, then the neural network 108 determines that the text segment includes a section title 114.

The segmentation neural network 108 includes an encoder.

In particular, to determine whether the text segment includes a marker, the segmentation neural network 108 calculates, for each marker of the plurality of markers, a marker embedding by using the encoder neural network. In some implementations, the segment neural network 108 calculates the marker embedding by processing the text in the marker using a universal sentence encoder. The universal sentence encoder is configured to receive as input an English string and produce as output a fixed dimensional embedding that represents the string. Example architectures of a universal sentence encoder is described in Daniel Cer, Yinfei Yang, Sheng-yi Kong, Nan Hua, Nicole Limtiaco, Rhomni St John, Noah Constant, Mario Guajardo-Cespedes, Steve Yuan, Chris Tar, et al. 2018. Universal sentence encoder for english. In Proceedings of the 2018 conference on empirical methods in natural language processing: system demonstrations, pages 169-174.

The segmentation neural network 108 is then configured to determine a probability of the text segment includes a marker by computing a level of similarity between (i) the text segment embedding 106 of the text segment, and (ii) the marker embedding of the marker. For example, the segmentation neural network 108 determines the probability by calculating a cosine similarity between the text segment embedding 106 and the marker embedding. The cosine similarity outputs a value between zero and one that could be considered the probability that the text segment includes a marker.

The section type classification neural network 110 is configured to, for each of the one or more text segments, process the respective set of text segment embeddings 106 to classify the text segment into a section type of a plurality of section types.

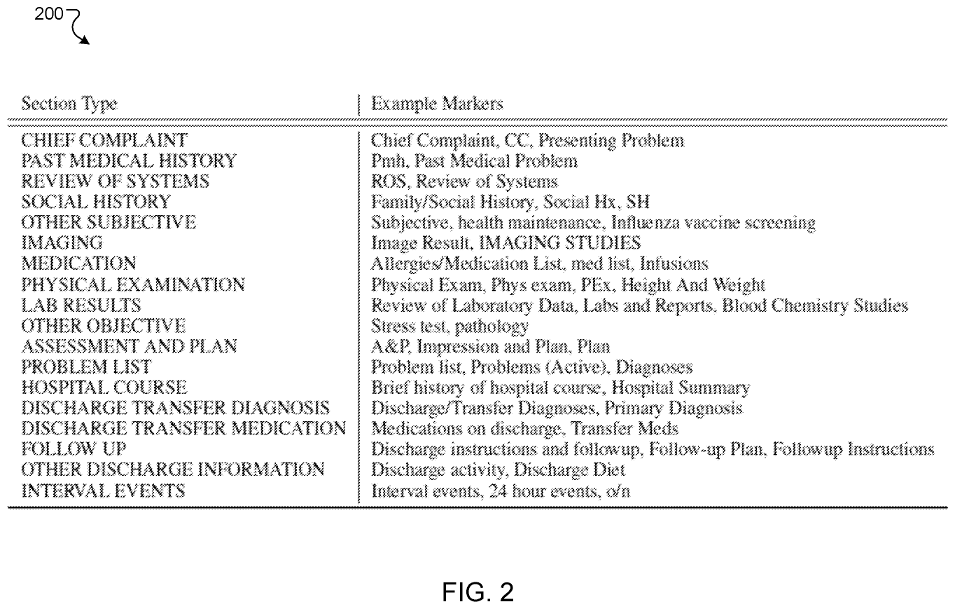

The section type characterizes a type of patient information or a type of a clinical procedure that resulted in the clinical note being generated. For example, the section type may be a historical section type that characterizes information related to a patient in the past, such as past medical history or social history. As another example, the section type may be a medical record section type that characterizes information related to the patient's medication, physical examination results, or lab results. As another example, the section type may be a discharge section type that characterizes information related to a patient's discharge from a hospital and/or the patient's transfer to another hospital. For example, a discharge section type may be discharge transfer diagnosis or discharge transfer medication. Some examples of section types are shown in FIG. 2.

FIG. 2 also shows corresponding markers for each example section type.

In some implementations, the section type neural network 110 includes one or more fully-connected neural network layers and a softmax neural network layer.

In some cases, the clinical note 101 may include phrases that were copied from a previous clinical note(s), or includes content of a separate report (e.g., a radiology report). Thus, in some implementations, the multi-task neural network system 100 includes a note type prediction neural network 112 that is configured to predict which type of the note that each text segment comes from. In particular, the note type prediction neural network 112 is configured to, for each of the one or more text segments, process the respective set of text segment embeddings 106 to determine a note type of the text segment. The note type characterizes a type of patient interaction that resulted in the clinical note being generated. For example, a note type may be (i) history and physical, (ii) progress, (iii) discharge summary, (iv) consult, (v) operative, or (v) an unspecified type for notes that do not have structures.

In some implementations, the note type prediction neural network 112 includes one or more fully-connected neural network layers and a softmax neural network layer.

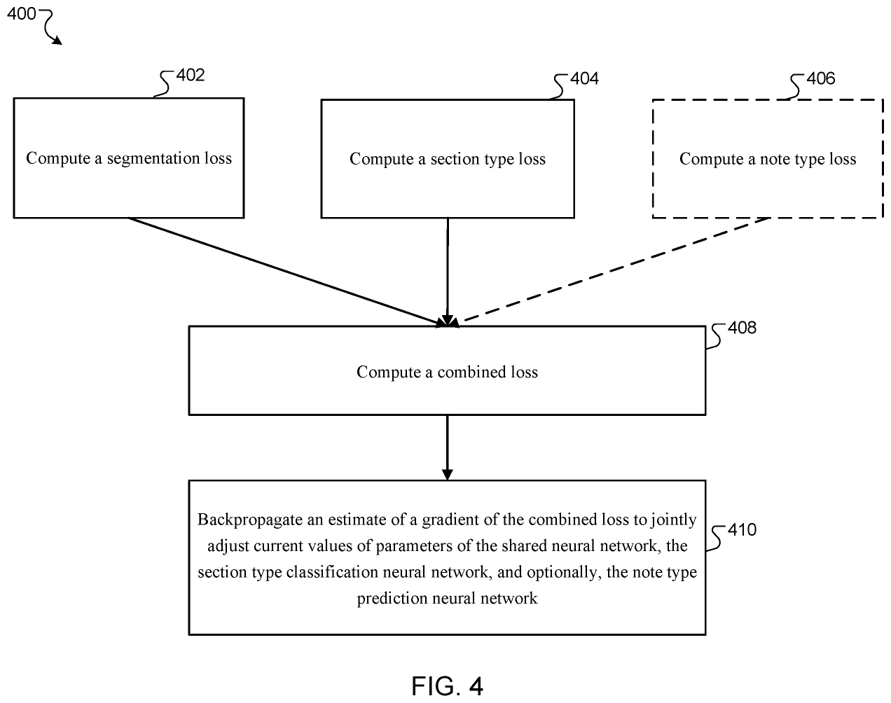

In some implementations, the shared neural network 104, the segmentation neural network 108, the section type classification neural network 110, and optionally, the note type prediction neural network 112 are jointly trained to optimize a combined loss. For example, the combined loss is a combination of (i) a segmentation loss that ensures an accuracy of classifying a text segment as a section title or not, (ii) a section type loss that ensures an accuracy of classifying a text segment into a section type of the plurality of section types, and optionally, (iii) a note type loss that ensures an accuracy of determining a note type for a text segment, in which the note type is one of a plurality of note types. In some implementations, the combined loss function is a weighted sum of the segmentation loss, the section type loss, and the note type loss. The process for jointly training the segmentation neural network 108, the section type classification neural network 110, and optionally, the note type prediction neural network 112 is described in detail below with reference to FIG. 4.

In some implementations, the segmentation neural network 108 is a pre-trained neural network. The segmentation loss can be used to train the shared neural network 104. The system can jointly train the shared neural network, the section type classification neural network 110 and optionally, the note type prediction neural network 112 on a combined loss that is computed based on the segmentation loss, the section type loss, and optionally the note type loss.

A clinical system that implements the multi-task neural network system 100 may receive a clinical note, segment the clinical note into a plurality of sections and determine a section title and section type for each of the plurality of sections using the multi-task neural network system.

Optionally or in addition, the clinical system may determine a note type for each text segment in each section.

The clinical system may label each of the plurality of sections with the respective section title, and organize the labeled sections according to the section types and/or note types of the labeled sections.

By implementing the multi-task neural network system 100, the clinical system can correctly classify sections from clinical notes across different healthcare systems (e.g., different hospital departments, different care providers or different Electronic Health Records (EHR) systems), allowing medical professionals and patients to better access information within different clinical notes from different systems.

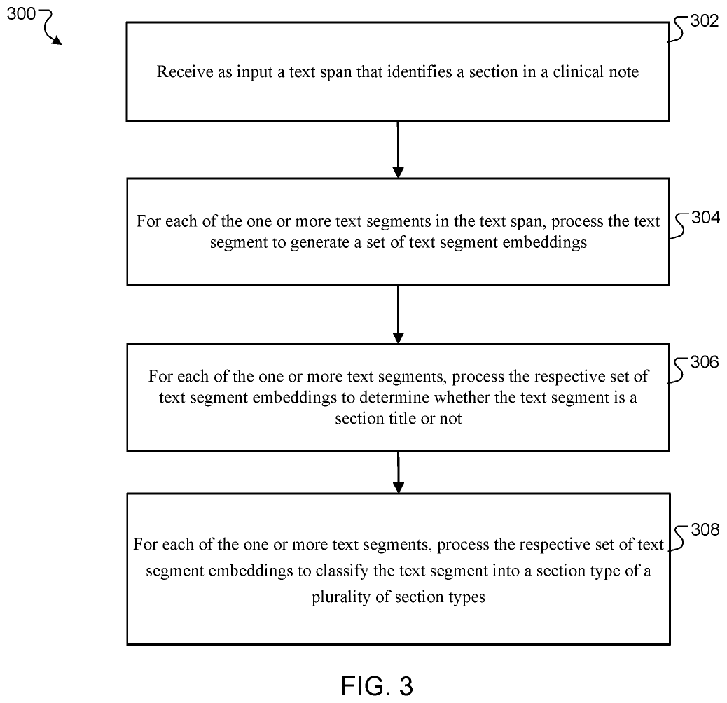

FIG. 3 is a flow diagram of an example process 300 for segmenting and classifying unstructured text in a clinical note. For convenience, the process 300 will be described as being performed by a system of one or more computers located in one or more locations. For example, a neural network system, e.g., the multi-task neural network system 100 of FIG. 1, appropriately programmed in accordance with this specification, can perform the process 300.

The system receives as input a text span from a clinical note (step 302). The text span includes one or more text segments. In some implementations, the one or more text segments include one or more sentences.

For each of the one or more text segments in the text span, the system processes, using a shared neural network, the text segment to generate a set of text segment embeddings (step 304).

In some implementations, the shared neural network includes an attention neural network. In some implementations, the attention neural network is a Transformer neural network. In some implementations, the attention neural network is a Bidirectional Encoder Representations from Transformers (BERT) neural network. In some implementations, the shared neural network includes one or more fully-connected neural network layers with dropout.

For each of the one or more text segments, the system processes, using a segmentation neural network, the respective set of text segment embeddings to determine whether the text segment is a section title or not (step 306).

For each of the one or more text segments, the system processes, using a section type classification neural network, the respective set of text segment embeddings to classify the text segment into a section type of a plurality of section types (step 308). The section type characterizes a type of a clinical procedure that resulted in the clinical note being generated. For example, a section type may be past medical history, review of systems, social history, imaging, medication, physical examination, lab results, assessment and plan, problem list, hospital course, discharge transfer diagnosis, discharge transfer medication, follow up, or interval events.

In some implementations, the section type neural network includes one or more fully-connected neural network layers and a softmax neural network layer.

In some implementations, for each of the one or more text segments, the system processes, using a note type prediction neural network, the respective set of text segment embeddings to determine a note type of the text segment. The note type characterizes a type of patient interaction that resulted in the clinical note being generated. For example, a note type may be (i) history and physical, (ii) progress, (iii) discharge summary, (iv) consult, (v) operative, or (v) an unspecified type for notes having no structures. In some implementations, the note type neural network includes one or more fully-connected neural network layers and a softmax neural network layer.

FIG. 4 is a flow diagram of an example process 400 for jointly training the shared neural network, the segmentation neural network, the section type classification neural network, and optionally, the note type prediction neural network. For convenience, the process 300 will be described as being performed by a system of one or more computers located in one or more locations. For example, a neural network system, e.g., the multi-task neural network system 100 of FIG. 1, appropriately programmed in accordance with this specification, can perform the process 400.

The system computes a segmentation loss that ensures an accuracy of classifying whether a text segment is a section title or not (step 402). In some implementations, the segmentation loss is a cross-entropy loss between (i) a predicted probability that an input text segment is a section title and (ii) a target probability that the input text segment is a section title. The segmentation neural network is configured to process the input text segment to generate the predicted probability. The target probability is the ground-truth output that the segmentation neural network should generate for the input text segment. The system may compute the segmentation loss over a batch of training examples, each training example including a respective training input (i.e., a respective input text segment) and a respective ground-truth output (i.e., a respective ground-truth output that includes a probability that the respective input text segment is a section title).

The system computes a section type loss that ensures an accuracy of classifying a text segment into a section type of the plurality of section types (step 404). The section type classification neural network is configured to process an input text segment to generate a predicted probability distribution that includes, for each of the plurality of section types, a respective score that indicates the likelihood that the section type is the section type of the text segment. In some implementations, the system computes the segmentation loss by computing a cross-entropy loss between (i) the predicted probability distribution generated by the section type classification neural network for the input text segment, and (ii) a target probability distribution associated with the input text segment. The system may compute the section type loss over a batch of training examples, each training example including a respective input text segment and a respective target probability distribution.

The system computes a note type loss that ensures an accuracy of determining a note type for a text segment, in which the note type is one of a plurality of note types (step 406). The note type prediction neural network is configured to process an input text segment to generate a predicted probability distribution that includes, for each of the plurality of note types, a respective score that indicates the likelihood that the note type is the note type of the clinical note that the text segment comes from. In some implementations, the system computes the note type loss by computing a cross-entropy loss between (i) the predicted probability distribution generated by the note type prediction neural network for the input text segment, and (ii) a target probability distribution associated with the input text segment. The system may compute the note type loss over a batch of training examples, each training example including a respective input text segment and a respective target probability distribution.

The system computes a combined loss based on the section type loss and optionally, a note type loss (step 408). In some implementations, the combined loss is a weighted sum of the segmentation loss, the section type loss, and optionally, the note type loss. In some other implementations, the combined loss is a weighted sum of the section type loss and the note type loss.

The system backpropagates an estimate of a gradient of the combined loss to jointly adjust current values of parameters of the shared neural network, the section type classification neural network, and optionally, the note type prediction neural network (step 410).

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework. Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A multi-task neural network system comprising one or more computers and one or more non-transitory computer storage media storing instructions that, when executed by the one or more computers, cause the one or more computers to implement:
a shared neural network configured to:
receive as input a text span from a clinical note, wherein the text span includes one or more text segments, and
for each of the one or more text segments in the text span, process the text segment to generate a set of text segment embeddings;
a segmentation neural network configured to, for each of the one or more text segments, process the respective set of text segment embeddings to determine whether the text segment is a section title or not; and
a section type classification neural network configured to, for each of the one or more text segments, process the respective set of text segment embeddings to classify the text segment into a section type of a plurality of section types, wherein the section type characterizes a type of a clinical procedure that resulted in the clinical note being generated.

2. The system of claim 1, wherein the shared neural network includes a deep neural network.

3. The system of claim 1, wherein the deep neural network includes one or more fully-connected neural network layers with dropout.

4. The system of claim 2, wherein the deep neural network includes a Transformer neural network.

5. The system of claim 4, wherein the Transformer neural network is a bidirectional Transformer encoder neural network.

6. The system of claim 1, wherein the segmentation neural network includes an encoder neural network.

7. The system of claim 1, wherein the section type neural network includes one or more fully-connected neural network layers and a softmax neural network layer.

8. The system of claim 1, further comprising: a note type prediction neural network configured to, for each of the one or more text segments, process the respective set of text segment embeddings to determine a note type of the text segment, wherein the note type characterizes a type of patient interaction that resulted in the clinical note being generated.

9. The system of claim 8, wherein the note type neural network includes one or more fully-connected neural network layers and a softmax neural network layer.

10. The system of claim 8, wherein the shared neural network, the section type classification neural network, and the note type prediction neural network are jointly trained to optimize a combined loss function.

11. The system of claim 10, wherein the combined loss function is a combination of a section type loss that ensures an accuracy of classifying a text segment into a section type of the plurality of section types and a note type loss that ensures an accuracy of determining a note type for a text segment, wherein the note type is one of a plurality of note types.

12. The system of claim 10, wherein the combined loss function is a weighted sum of a segmentation loss, a section type loss, and a note type loss.

13. One or more non-transitory computer storage media storing instructions that, when executed by one or more computers, cause the one or more computers to perform operations comprising:
receiving, by a shared neural network, as input a text span from a clinical note, wherein the text span includes one or more text segments, and for each of the one or more text segments in the text span, processing the text segment to generate a set of text segment embeddings;
for each of the one or more text segments, processing, by a segmentation neural network, the respective set of text segment embeddings to determine whether the text segment is a section title or not; and
for each of the one or more text segments, processing, by a section type classification neural network, the respective set of text segment embeddings to classify the text segment into a section type of a plurality of section types, wherein the section type characterizes a type of a clinical procedure that resulted in the clinical note being generated.

14. The one or more non-transitory computer storage media of claim 13, wherein the multi-task neural network system includes a note type prediction neural network, and wherein the operations further comprise:
for each of the one or more text segments, processing, using the note type prediction neural network, the respective set of text segment embeddings to determine a note type of the text segment, wherein the note type characterizes a type of patient interaction that resulted in the clinical note being generated.

15. The one or more non-transitory computer storage media of claim 14, wherein shared neural network, the section type classification neural network, and the note type prediction neural network are jointly trained to optimize a combined loss function.

16. The one or more non-transitory computer storage media of claim 15, wherein the combined loss function is a combination of a section type loss that ensures an accuracy of classifying a text segment into a section type of the plurality of section types and a note type loss that ensures an accuracy of determining a note type for a text segment, wherein the note type is one of a plurality of note types.

17. A computer-implemented method for segmenting and classifying unstructured text in a clinical note using a multi-task neural network system that includes a shared neural network, a segmentation neural network, and a section type classification neural network, the method comprises:
receiving, by a shared neural network, as input a text span from a clinical note, wherein the text span includes one or more text segments, and for each of the one or more text segments in the text span, processing the text segment to generate a set of text segment embeddings;
for each of the one or more text segments, processing, by a segmentation neural network, the respective set of text segment embeddings to determine whether the text segment is a section title or not; and
for each of the one or more text segments, processing, by a section type classification neural network, the respective set of text segment embeddings to classify the text segment into a section type of a plurality of section types, wherein the section type characterizes a type of a clinical procedure that resulted in the clinical note being generated.

18. The method of claim 17, wherein the multi-task neural network system includes a note type prediction neural network, and wherein the operations further comprise:
for each of the one or more text segments, processing, using the note type prediction neural network, the respective set of text segment embeddings to determine a note type of the text segment, wherein the note type characterizes a type of patient interaction that resulted in the clinical note being generated.

19. The method of claim 18, wherein the shared neural network, the section type classification neural network, and the note type prediction neural network are jointly trained to optimize a combined loss function.

20. The method of claim 19, wherein the combined loss function is a combination of a section type loss that ensures an accuracy of classifying a text segment into a section type of the plurality of section types and a note type loss that ensures an accuracy of determining a note type for a text segment, wherein the note type is one of a plurality of note types.
